(19) United States
(12) Patent Application Publication
(10) Pub. No.: US 2019/0311343 A1
(43) Pub. Date: Oct. 10, 2019

(54) POINT OF SALE SYSTEM NETWORK WITH DISTRIBUTED OWNERSHIP RECORD DATABASE

(71) Applicant: Walmart Apollo, LLC, Bentonville, AR (US)

(72) Inventors: Robert L. Cantrell, Herndon, VA (US); Donald R. High, Noel, MO (US); Todd D. Mattingly, Bentonville, AR (US); Philip Alexander Stout, Manchester (GB); David M. Nelms, Rogers, AR (US)

(21) Appl. No.: 16/365,264

(22) Filed: Mar. 26, 2019

Related U.S. Application Data
(60) Provisional application No. 62/654,079, filed on Apr. 6, 2018.

(51) Int. Cl. G06Q 20/20; H04L 9/06; G06Q 20/38; G06Q 50/28

(52) U.S. Cl. CPC G06Q 20/202; G06Q 20/203; G06Q 20/209; G06Q 50/28; H04L 9/0637; G06Q 20/3829; G06Q 20/204

(57) ABSTRACT

Systems, apparatuses, and methods are provided herein for a rule-based electronic checkout system based on a distributed digital ledger. A point of sale system is configured to receive a transaction request for a selected product, receive a customer public key, index a disturbed digital ledger to determine the user's ledger unit count for a selected product, request and verify a ledger transfer, and authorize the transaction based on the ledger transfer.

### CROSS-REFERENCE TO RELATED APPLICATIONS

This application claims the benefit of U.S. Provisional Application No. 62/654,079, filed Apr. 6, 2018, which is incorporated herein in its entirety.

### TECHNICAL FIELD

This invention relates generally to point of sale systems.

### BACKGROUND

A point of sale (POS) system is an electronic system for processing customer purchases. A conventional POS system tallies up the amount owed by the customer based on items the customer brought to a checkout counter and accepts payment for the purchase of the items.

### BRIEF DESCRIPTION OF THE DRAWINGS

Disclosed herein are embodiments of apparatuses and methods for a rule-based electronic checkout system. This description includes drawings, wherein:

FIG. 1 is a system diagram of a system in accordance with several embodiments;

FIG. 2 is a block diagram in accordance with several embodiments; and

FIG. 3 is a process diagram in accordance with several embodiments;

FIG. 4 is a flow diagram of a method in accordance with several embodiments;

FIG. 5 is a process diagram of a process in accordance with several embodiments;

FIG. 6 comprises an illustration of blocks in accordance with several embodiments;

FIG. 7 comprises an illustration of transactions in accordance with several embodiments;

FIG. 8 comprises a flow diagram in accordance with several embodiments;

FIG. 9 comprises a process diagram in accordance with several embodiments;

FIG. 10 comprises an illustration of a delivery record in accordance with several embodiments; and

FIG. 11 comprise a system diagram in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for a rule-based electronic checkout system. The system comprises a plurality of point of sale (POS) systems comprising nodes of a distributed digital ledger, wherein the distributed digital ledger comprises ownership records associated with a plurality of user accounts that are updated and verified collectively by the plurality of POS systems, and wherein the distributed digital ledger is configured to be used by one or more of the plurality of POS systems to authorize transfer of items specified in the ownership records to customers. A POS system in the plurality of POS systems comprises a memory device configured to store at least a portion of the distributed digital ledger, an optical scanner configured to detect product identifiers and/or user account identifiers, and a control circuit coupled to the memory device and the optical scanner, the control circuit being configured: periodically communicate with others of the plurality of POS systems to update the ownership records in the at least a portion of the distributed digital ledger, receive a transaction request comprising a product identifier associated with a product and a transfer unit count (Ut) wherein the transfer unit count (Ut) corresponds to units of product the customer wishes to take into physical prosession, receive, from a customer via the optical scanner, a public key associated with a user account, index the distributed digital ledger using the public key associated with the user account for ownership records associated with the user account to determine a ledger unit count (U) associated with the product identifier, wherein the ledger unit count (Ul) corresponds to product units previously added to the user account and not yet physically conveyed, in the event the transfer unit count is equal or lesser than the ledger unit count (Ut≤Ul): provide a public key associated with the retail entity account to the customer, request the user account for a ledger transfer from the user account to a retail entity account associated with the POS system in a unit count amount equal to the transfer unit (Ut), wherein the ledger transfer is broadcasted to the plurality of POS systems for verification; confirm the ledger transfer to the retail entity account based on updates to the distributed digital ledger and authorize the transaction request at the POS system in response to confirming the ledger transfer.

Referring now to FIG. 1, an electronic checkout system network according to some embodiments is shown. The system 100 includes a plurality of POS systems 120 communicating over a network via a distributed digital ledger 110. The distributed digital ledger 110 is further accessed by one or more user device 130.

The distributed digital ledger 110 comprises a distributed database for storing ownership records associated with a plurality of user accounts. The distributed ledger may be stored on a plurality of POS systems 120, user devices 130, and/or other processor-based devices. In some embodiments, the nodes of the distributed digital ledger comprise systems associated with retailers, manufacturers, suppliers, and/or customers. In some embodiments, the distributed digital ledger 110 comprises one or more of a shared ledger, a distributed database, a hash chain database, a blockchain database, and a blockchain-based database. In some embodiments, the distributed digital ledger 110 comprises a hash chain in which ownership transaction records are collected into blocks and each block contains a hash of the previous block in the chain. In some embodiments, transactions and changes of ownership are broadcasted to and verified collectively by the nodes of the distributed ledger.

In some embodiments, the distributed digital ledger 110 comprises digital records of purchases and ownership transfers associated with customer accounts and/or customer entity identifiers. When a customer purchases an item but does not take physical possession of an item (e.g. carry the item out of the store, order the item for delivery), the distributed digital ledger 110 may be updated to add records of ledger ownership to the user account and specify a ledger unit count (Ul). When the user wishes take physical possession of the item at a later time, the user can use the record in the distributed digital ledger 110 as proof of ownership and receive the item in exchange. The user may also transfer ownership of items to other users by making a transfer through the distributed digital ledger 110. In some embodiments, each unit of the product may be received and transferred individually. For example, a customer may purchase a 12-pack soda on a first day, pick up 2 cans from a store on the second day, get 1 can from a vending machine on a third day, give 6 cans to a friend on a fourth day through ledger transfer, and purchase another 6-pack on a fifth day. On the fifth day, the ledger unit count (UL) in the customer account would be 9. In some embodiments, ownership records for units of products are transferred with a process similar to the transfer of currency in a block-chain based cryptocurrency system. For example, when an item is first purchased, the ownership record for the purchased units may be transferred from the retail entity to the customer as proof of purchase. When the customer wants to take physical possession of the item, the ownership record for the units of product may be “spent” and transferred back to the retail entity. In some embodiments, the ledger unit count of an item associated with a customer comprises items previously purchased by the customer and/or for the customer but has not been physically conveyed to the customer (e.g. by pick up or delivery). In some embodiments, the ledger ownership count in the distributed digital ledger may be considered an ownership token that may be exchanged for a specific physical item. Generally, the ownership record of products is insulated from price variations. That is, once a product is purchased and recorded in the distributed digital ledger, the customer can request the conveyance of the price even if the current price of the product is higher than the purchase price. In some embodiments, a retailer may offer a price adjustment if the unit price of the product drops. For example, if the purchase price of a product is higher than the current price, the retailer may offer the difference as cash back or store credit when the conveyance of the product is requested. In some embodiments, the distributed digital ledger of product ownership may comprise a side chain of a cryptocurrency blockchain or a standalone ledger.

The distributed digital ledger 110 may be stored, verified, and updated by a plurality of POS systems 120, a user device 130, retailer central computer systems and the like, that act as nodes of the distributed digital ledger 110. While the distributed digital ledger 110 is separately shown from the POS systems 120 and the user device in FIG. 1 for illustrative purposes, it is understood that the distributed digital ledger 110, being distributed, comprises data stored on one or more POS systems 120, user device 130, and/or other devices. In some embodiments, a POS system 120 may store a portion or an entire copy of the distributed digital ledger 110. In some embodiments, a group of POS systems 120 may access the distributed digital ledger 110 via a central retailer system that provides the verification and update processing for supporting the distributed digital ledger 110. For example, a central computer system of a retail entity may batch index the distributed digital ledger 110 and maintain a database of customer ownership records in a conventional database format. In some embodiments, the processing power for updating and verifying the distributed digital ledger 110 may be shared between a group of POS systems 120. For example, POS systems not currently being used (e.g. systems in closed store, closed lanes) may provide the processing power for indexing, updating, and/or verifying the distributed digital ledger 110 for other POS systems in the group.

In some embodiments, the distributed digital ledger 110 may be shared by a plurality retail entities for purchases and item transfers. For example, a customer may use the distributed digital ledger 110 to purchase products from one store (e.g. Sam's club) and request the transfer of the product from another store (e.g. Walmart). In another example, a customer may purchase items from an online store and request items to be dispensed from a vending machine configured to access the distributed digital ledger 110.

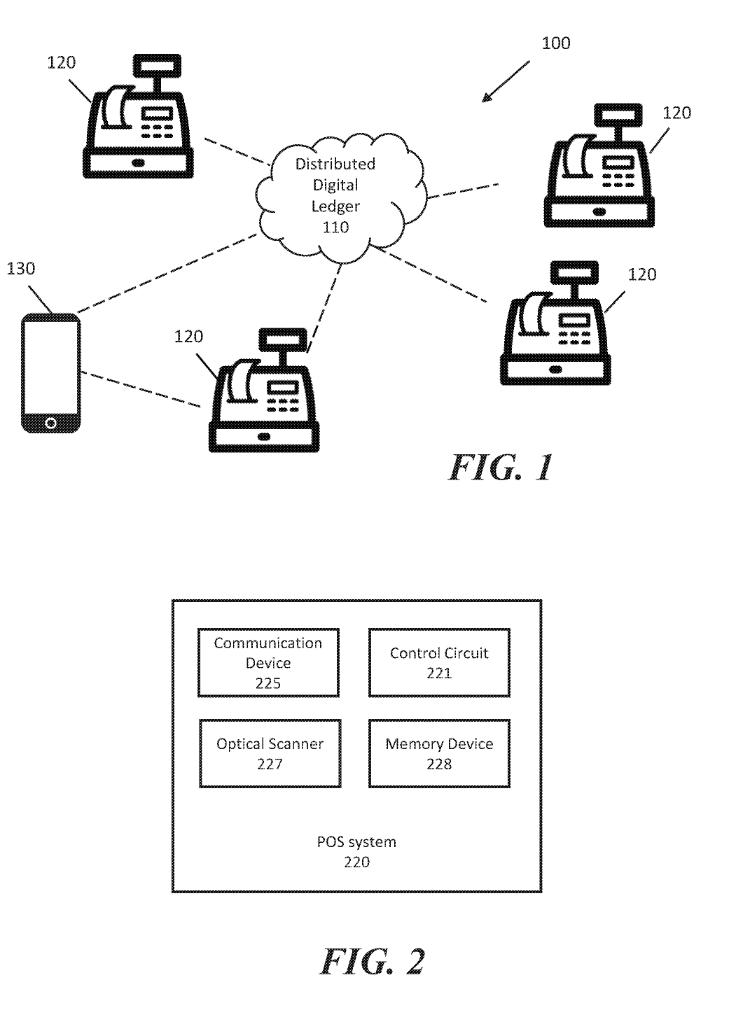

A POS system 120 comprises an electronic system for processing customer transactions. A POS system, as used herein, may refer to one or more of a retail management system, a central computer system supporting a plurality of checkout terminals, an online store checkout system, a retail store checkout terminal, a cash register, a self-service checkout terminal, a vending machine, an automated item dispensing machine, and the like. Generally, a POS system may refer to a system that accepts and/or processes customer product purchases. In some embodiments, a POS system 120 comprises a control circuit, a memory device, a communication device, and one or more input/output devices such as a touch screen, a display screen, a keypad, an optical scanner, a Radio Frequency Identification (RFID) reader, a card reader, a scale, a speaker, a microphone, and the like. In some embodiments, a POS system 120 comprises a memory device configured to store at least a portion of the distributed digital ledger 110, an optical scanner configured to detect product identifiers and/or user account identifiers, and a control circuit coupled to the memory device and the optical scanner. The POS system may be configured to receive product identifiers from a product and/or user device 130 and user identifier from the user device 130 to determine a transaction request. The POS system 120 may further be configured to determine how much to charge the customer for a transaction based on the ownership records in the distributed digital ledger 110. In some embodiments, one or more the POS systems 120 comprises nodes of the distributed digital ledger 110 and collectively update and verify the distributed digital ledger 110 based on transactions with customers. An example of a POS system 120 in the system 100 is described with reference to FIG. 2 herein.

The user device 130 comprises a customer operated device configured to be used with the POS system 120 for transactions. In some embodiments, the user device 130 may comprise a mobile phone, a smartphone, a wearable device, a tablet computer, and the like. In some embodiments, the user device 130 may comprise a device carried into the store by the customer. In some embodiments, the user device may comprise store provided user interface device. In some embodiments, the user device 130 may execute a software program (e.g. mobile application) that allows the customers to perform transactions via the distributed digital ledger 110. In some embodiments, the user interface application on the user device 130 may display a user identifier and/or a public key to be read by an optical scanner of a POS system 120. In some embodiments, the user device 130 may use near-field communication (NFC) to send the public key to the POS system 120. In some embodiments, the user interface on the user device 130 may allow the user to scan an item identifier (e.g. barcode, QR code) with an optical sensor (e.g. camera) and display the ledger unit count of the item to the user. In some embodiments, the user interface may comprise a virtual inventory user interface that allows the user to view items they own but have not taken into physical possession. In some embodiments, the user interface on the user device 130 may allow the user to receive a public key associated with a retail entity and send up ownership update to the distributed digital ledger 110. In some embodiments, the user device 130 may use near-field communication (NFC) to receive the public key of the retail entity from POS system 120. In some embodiments, the user device 130 may be omitted in a transaction and the user may operate a user interface provided on the POS system to perform functions of the user device 130 described herein.

The nodes of the distributed digital ledger 110, which may comprise one or more of the POS systems 120 and one or more user device 130, communicates with each other over a network such as the Internet, a secure network, a private network, a virtual privet network, an encrypted network, etc. In some embodiments, the user device 130 may directly communicate with a POS system 120 via NFC, Bluetooth, WiFi, or by displaying and capturing optical codes (e.g. barcode, QR code). In some embodiments, the nodes of the distributed digital ledger 110 may comprise other types of devices such as manufacturer systems, supplier systems, personal computers, internet of things (IoT) devices, and other processor-based devices.

Referring now to FIG. 2, a POS system according to some embodiments is shown. The POS system 220 comprises a communication device 225, a control circuit 221, an optical scanner 227, and a memory device 228. The POS system 220 generally refers to an electronic system for processing customer transactions. A POS system, as used herein, may refer to one or more a central computer system supporting a plurality of checkout terminals, a retail management system, an online store checkout system, a retail store checkout terminal, a cash register, a store clerk checkout terminal, a self-service checkout terminal, a vending machine, an automated item dispensing machine, and the like. Generally, a POS system may refer to a system that accepts and/or processes product purchases. In some embodiments, the POS system 220 may comprise at least one of the POS systems 120 described with reference to FIG. 1 herein.

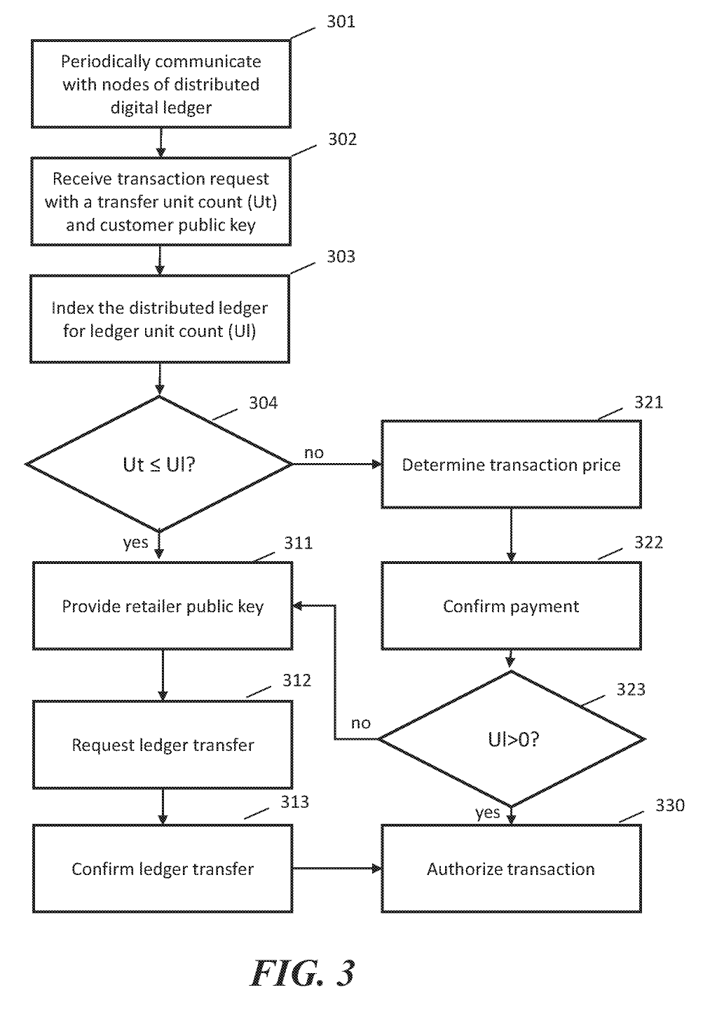

The control circuit 221 may comprise a processor, a microprocessor, and the like and may be configured to execute computer readable instructions stored on a computer-readable storage memory device 228. The control circuit 221 may be communicatively coupled to one or more other POS systems, user devices, and/or distributed digital ledger nodes. The computer-readable storage memory device 228 may comprise volatile and/or non-volatile memory and have stored upon it a set of computer readable instructions which, when executed by the control circuit 221, cause the control circuit 221 to process and authorize customer transfer requests based on the ownership record information in a distributed digital ledger. In some embodiments, the control circuit 221 may further be configured to determine an amount owed by the customer based on the transfer request and the ownership records in the distributed digital ledger. In some embodiments, the control circuit 221 may further be configured to update the distributed database based on transactions with customers. In some embodiments, the control circuit 221 executing codes stored on the memory device 228 may be configured to perform one or more steps described with reference to FIGS. 3-5 herein.

The memory device 228 may further be configured to store a least a portion of a distributed digital ledger. In some embodiments, the distributed digital ledger 110 may be stored on a central system and/or individual check out terminals of the retail management system. In some embodiments, the memory device 228 may be shared by one or more POS systems. The distributed digital ledger stored in the memory device 228 may be continuously and/or periodically updated based on communications with other nodes of the distributed digital ledger. In some embodiments, the control circuit 221 is configured to update a customer ownership records database stored on the memory device 228 based on monitoring updates to the distributed digital ledger.

The communication device 225 may comprise one or more of a network adopter, a Wi-Fi transceiver, a Bluetooth transceiver, an NFC transceiver, a mobile data network transceiver, and the like. In some embodiments, the communication device 225 may be configured to allow the control circuit 221 to communicate with one or more other nodes of a distributed ledger and/or user devices operated by customers.

The optical scanner 227 comprises an input device for reading optical codes. In some embodiments, the optical scanner 227 may comprise a barcode reader, a QR code reader, a handheld scanner and the like. In some embodiments, the optical scanner is configured to detect product identifiers and/or user account identifiers. For example, the optical scanner 227 may be configured to read barcodes on products to identify products the customer wishes to receive with a transaction. In some embodiments, the optical scanner 227 may further be configured to scan an image displayed on a user device to receive the customer's user account identifier and/or distributed ledger public key. In some embodiments, in addition to or in place of an optical scanner, the POS system 220 may comprise a short-range communication device such as an RFID reader, an NFC transceiver, a Bluetooth transceiver, etc. for receiving product identifier, customer account identifier, and/or customer public key. In some embodiments, the POS system 220 may further comprise other user input/output devices such as a touch screen, a display screen, a keypad, an optical scanner, a card reader, a scale, a speaker, a microphone, and the like. In some embodiments, the optical scanner 227 may be omitted from a POS system of an online store. In some embodiments, a user device camera may be used as an optical scanner 227 for an online store POS system.

Referring now to FIG. 3, a method for an electronic checkout system is shown. In some embodiments, the steps shown in FIG. 3 may be performed by a processor-based device, such as one or more of the POS system 120 and the user device 130 described with reference to FIG. 1, the POS system 220 described with reference to FIG. 2, or other similar devices. In some embodiments, the steps may be performed by one or more of a processor POS system, a central computer system, and/or a user device.

In step 301, the system communicates with others of the plurality of POS systems to update the ownership records in a distributed digital ledger. In some embodiments, the plurality of point of sale (POS) systems comprises nodes of the distributed digital ledger, wherein the distributed digital ledger comprises ownership records associated with a plurality of user accounts that are updated and verified collectively by the plurality of POS systems and wherein the distributed digital ledger is configured to be used by one or more of the plurality of POS systems to authorize transfer of items specified in the ownership records to customers. In some embodiments, the POS systems may execute a computer program for the distributed digital ledger that updates and verifies the digital ledger along with other POS systems. In some embodiments, the distributed digital ledger comprises one or more of a shared ledger, a distributed database, a hash chain database, a blockchain database, and a blockchain-based database. In some embodiments, the nodes of the distributed digital ledger comprise systems associated with two or more of retailers, manufacturers, suppliers, and customers. In some embodiments, a group of POS systems may share the performance of step 301. For example, one or more idle POS systems (e.g. in a closed checkout lane) may perform step 301 and share the updated distributed digital ledger with other POS systems.

In step 302, the system receives a transaction request and user public key. In some embodiments, the transaction request comprises a product identifier associated with a product and a transfer unit count (Ut). Transfer unit count (Ut) generally refers to units of product the customer wishes to take into physical possession with the transaction. In some embodiments, a transaction request made by a customer in a brick-and-mortar retail store may comprise the items the customer brings to a checkout counter. The POS system may be configured to scan product identifiers on the products and count the number of products to determine the transaction request. In some embodiments, a transaction request made through an online store may comprise items the customer adds to a virtual shopping cart for delivery. In some embodiments, a transaction request made through a vending machine may comprise a selection of product(s) through a user interface of the vending machine. In some embodiments, the transaction request may comprise a ledger purchase request which adds to the ledger unit count of the selected product to a customer account. In some embodiments, a ledger purchase request comprises a product identifier associated with a product to purchase and a purchase unit count (Up). In some embodiments, the ledger purchase request may comprise a gift purchase from a first customer to a second customer associated with the receiving user account. In some embodiments, the ledger purchase request comprises a peer-to-peer transfer of ownership from one user account to the receiving user account.

In some embodiments, the user account public key may be received via an optical scanner of a POS system. The optical scanner may be configured to also detect product identifiers and/or user account identifiers. In some embodiments, the user account public key may be displayed on a user device as an optical code (e.g. barcode, QR code), text, and/or image. In some embodiments, in addition to or in place of the optical scanner, the user account public key may be provided via NFC or over a network such as an Internet. In some embodiments, a customer account identifier may be provided in addition to or in place of the customer public key in step 302, and step 303 is performed using the customer account identifier.

In step 303, the system indexes the distributed ledger. In some embodiments, the system indexes the distributed digital ledger using the public key associated with the user account for ownership records associated with the user account to determine a ledger unit count (Ul) of a product associated with the product identifier. The ledger unit count (Ul) generally refers to product units previously added to the user account and not yet conveyed. In some embodiments, ledger unit count may be added to the customer account when the customer makes a ledger purchase and/or when items are gifted by third parties through the ledger. In some embodiments, in step 303, the system may identify records associated with the customer account in the distributed ledger and identify transaction records for the item identified in the transaction request. The ledger unit count (Ul) may correspond to the number of units added to the account (e.g. through purchase, peer-to-peer transfer etc.) but not yet transferred out of the account (e.g. to a retail store in exchange of the physical item or to another customer account). In some embodiments, the system may periodically index the distributed digital ledger and maintain a non-distributed database of customer ownership records. Step 303 may be performed by retrieving records from a database of previously indexed data.

Step 304, the system determines whether the transfer unit count is equal or less than the ledger unit count (Ut≤Ul). If Ut≤Ul, in step 311, the system provides a public key associated with the retail entity account to the customer. In some embodiments, the public key may be provided via a displayed/printed image that the user can scan with a user device image sensor and/or may be provided via NFC. In some embodiments, the public key may be stored on the user device from a previous transaction and reused.

In step 312, the system requests a ledger transfer from the customer. In some embodiments, the system requests a ledger transfer from the user account to a retail entity account associated with the POS system in a unit count amount equal to the transfer unit (Ut). In some embodiments, the request may comprise a display on the POS system with instructions to perform the transfer. In some embodiments, the request may be sent through a retailer mobile application running on the user device. In some embodiments, the request may be sent via the distributed ledger application running on the user device. In some embodiments, the request may be made via the distributed ledger.

In step 313, the system confirms the ledger transfer. In some embodiments, the system confirms the ledger transfer to the retail entity account based on updates to the distributed digital ledger. In some embodiments, the ledger transfer may be similar to the transfer of token/coin in a cryptocurrency system. For example, the customer may sign a transaction record to transfer the transfer unit count (Ut) of the product to the public key of the retail entity. In some embodiments, the system verifies that the transferred ledger unit count matches the transfer unit count (Ut) and the transfer account matches the customer account. After the ledger transfer is confirmed, the system proceeds to step 330 and authorizes the transaction. For an in-store customer, in step 330, the customer is checked out and allowed to carry the products out of the retail store. For an online store POS system, in step 330, the customer receives an order confirmation and delivery instruction is sent to an order fulfillment system for processing. For a vending machine POS system, in step 330, the product specified in the transaction request is dispensed to the customer. In some embodiments, the customer may select to transfer only a portion of their total ledger unit count and pay for the difference between the transfer unit count (Ut) and the transferred ledger unit count through the POS system. For example, if Ut=3 and Ul=5, but the customer only wishes to use 1 ledger unit, the customer may pay the current price for the remaining 2 units of products. In some embodiments, the customer may pay for more products then they wish to take into physical possession right away. For example, if Ut=3, the customer may select to pay for 5 units and the POS system may update the distributed digital ledger to add 2 ledger units to the customer's account.

If the transfer unit counter (Ut) is greater than the ledger unit count (Ul), the system proceeds to step 321 and the system determines a transaction price for the transaction request. The transaction price may be determined based on (product unit price)*(Ut−Ul), wherein the product unit price corresponds to the current selling price of the product. The transaction price may further include other taxes and fees. In some instance, the product unit price at the time of the transaction may be different from the purchase price of ledger units of the same item. For example, the ledger unit counts may have been bought in bulk at a bulk discount price or bought during a promotional period. Generally, the customer may request conveyance of the product without paying for the price difference as the product was already paid for. In some embodiments, a retailer may offer a price adjustment if the unit price of the product drops. For example, if the purchase price of a product is higher than the current price, the retailer may offer the difference as cash back or store credit when the conveyance of the product is requested. In step 322, the system confirmed that the payment has been received. Payment may comprise cash payment, bank card payment, mobile payment, cryptocurrency payment, and the like. In some embodiments, the cryptocurrency blockchain used to pay for the transaction may be linked to the distributed digital ledger storing customer ownership records. In step 322, the system confirms that the payment is received. In some embodiments, step 322 may comprise conventional payment verification.

In step 323, the system determines whether Ul is greater than zero and/or determines whether the transaction involves ledger transfer in addition to the payment received in step 321. If ledger transfer is required, the system proceeds to step 311 and the customer transfers ledger unit counts in the customer account to the retail entity. If no ledger transfer is involved in a particular transaction because the customer has no ledger unit count for the selected item, the process proceeds to step 330 and the transaction is authorized.

In some embodiments, one or more steps in FIG. 3 may be repeated for a plurality different products for a single transaction. For example, if the transaction request includes two or more products, the system may determine whether there are sufficient ledger units for each product in the customer's account in steps 303 and 304. The system may further verify that the correct ledger units have been transferred for each product in step 313. In some embodiments, a POS system may be configured to support multiple instances of the process shown in FIG. 3 at different check out terminals and/or user interfaces.

In some embodiments, the system may omit steps 303, 304, and 312 and passively wait for the customer to transfer ledger units in step 313. If the ledger unit count transferred to the retailer is less than Ut, the system may then determine a transaction price based on the difference and authorize the transaction upon payment for the difference.

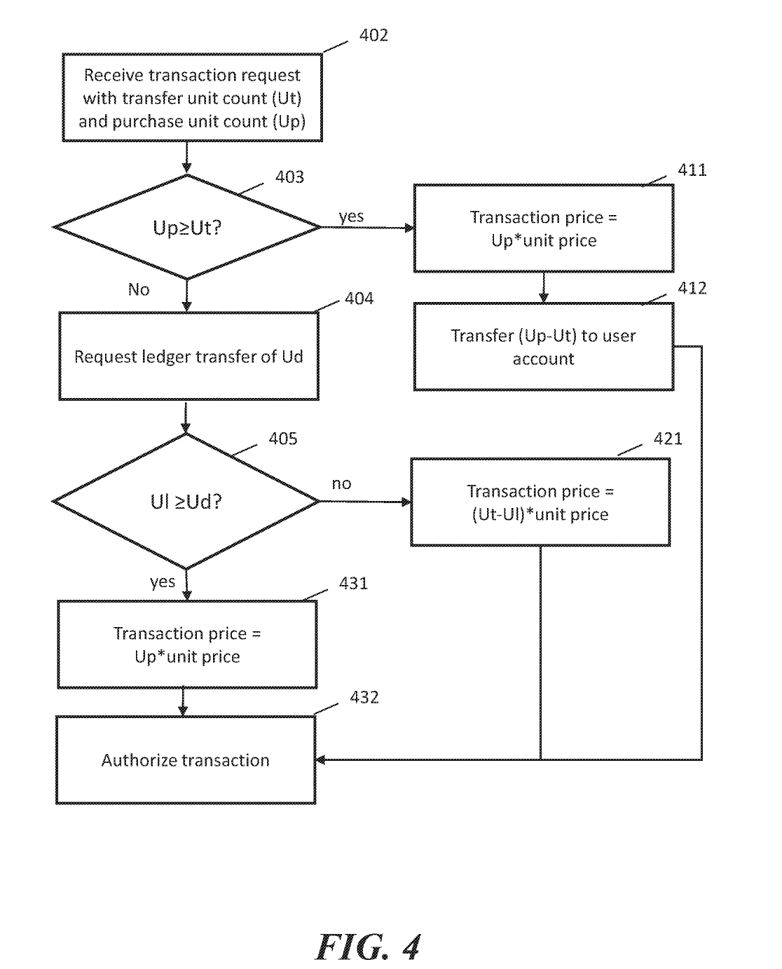

Referring now to FIG. 4, a method for an electronic checkout system is shown. In some embodiments, the steps shown in FIG. 4 may be performed by a processor-based device, such as one or more of the POS system 120 and the user device 130 described with reference to FIG. 1, the POS system 220 described with reference to FIG. 4, or other similar devices. In some embodiments, the steps may be performed by one or more of a processor POS system, a central computer system, and/or a user device.

In step 402, the system receives a transaction request comprising a transfer unit count (Ut) and a purchase unit count (Up) for a product. Transfer unit count (Ut) generally refers to the number of products the customer wishes to be conveyed into their physical possession. Purchase unit count (Up) generally refers to the number of products the customer wishes to pay for. In some embodiments, the transaction request may comprise a purchase-only transaction and the transfer unit count is set to zero. In some embodiments, the transaction may comprise a transfer-only transaction and the purchase unit account is set to zero. In some embodiments, step 402 may comprise step 301 described with reference to FIG. 3 herein.

In step 403, the system determines whether purchase unit count (Up) is greater than the transfer unit count (Ut). If the customer is paying for more product then they wish to take, in step 411, the transaction price is calculated based on Up multiplied by the unit price of the product. The total transaction price may include other taxes and fees. In step 412, the system adds the difference (Ud) between Up and Ut to the user's distributed ledger account as a ledger transaction update.

If Up is less than Ut, in step 404, the system requests for a ledger transfer to make up for the difference (Ud). In some embodiments, the request may be displayed on a POS system, through a mobile application, and/or made through the distributed digital ledger. In step 405, the system determines whether the user has sufficient ledger unit count (Ul) to cover the difference between Ut and Up. In some embodiments, the system may index the distributed ledger to determine Ul. In some embodiments, the system may use the unit count transferred to the retail entity in response to the ledger transfer request as Ul. In some embodiments, the ledger transfer may be performed according to steps 311, 312, and 313 described with reference to FIG. 3 or a similar process.

If there is sufficient Ul to make up for the difference between Ut and Up, in step 431 the transaction price is determined to be Up*unit price, and the transaction is authorized in step 432 after the payment is received and the ledger transfer is confirmed. In some embodiments, step 432 may comprise step 330 described with reference to FIG. 3 or a similar process. If there Ul is less than Ud, in step 421, the system determines the transaction cost based on (Ut−Ul)*(unit price) such that the transaction price covers the difference between the number of products the customer wishes to receive (Ut) and the ledger unit count (Ul) the customer transfers to the retail entity. After payment is received from the customer, the transaction is authorized. In some embodiments, step 432 may comprise step 330 described with reference to FIG. 3 or a similar process.

One or more steps in FIG. 4 may be repeated for a plurality different products for a single transaction. In some embodiments, a POS system may be configured to support multiple instances of the process shown in FIG. 4 at different terminals and/or user interfaces.

In some embodiments, a rule-based electronic checkout system comprises a memory device configured to store at least a portion of a distributed digital ledger comprising ownership records associated with a plurality of user accounts that are updated and verified by a plurality of nodes, a point of sale (POS) system comprising an optical scanner configured to detect product identifiers and/or user account identifiers, and a control circuit coupled to the memory device and the POS system. The control circuit being configured to receive a transaction request, from the POS system, comprising a product identifier associated with a product, a purchase unit count (Up), a transfer unit count (Ut), and a public key associated with a user account, wherein the purchase unit count (Up) corresponds to units of product a customer wishes to pay for in a transaction and the transfer unit count (Ut) corresponds to units of product the customer wishes to physically carry out or receive through delivery with the transaction, index the distributed digital ledger using the public key associated with the user account for ownership records associated with the user account in to determine a ledger unit count (Ul) associated with the product identifier, wherein the ledger unit count (Ul) corresponds to product units previously added to the user account and not yet physically conveyed, determine a difference (Ud) between the transfer unit count and the purchase unit count (Ud=|Ut−Up|), in the event that the purchase unit count is greater than or equal to the transfer unit count (Up≥Ut): add a record to the distributed digital ledger to add the difference to the ledger unit count of the product to the user account (Ul′=Ul+Ud), determine a charge amount (C) based on a first rule comprising C=Up*Cp, wherein Cp corresponds to a current price of the product, and in the event that the transfer unit count is greater than the purchase unit count (Pc<Tc) and the difference is equal to or lesser than the ledger unit count (Ud≤Ul): request the user account for a ledger transfer from the user account to a retail entity account in a unit count amount equal to the difference (Ud), signal the POS system when the ledger transfer is confirmed, and determine the charge amount (C) based on the first rule comprising C=Up*Cp, in the event that the transfer unit count is greater than the purchase unit count (Up<Ut) and the difference is greater than the ledger unit count (Ud>Ul): request the user account for a ledger transfer from the user account to the retail entity account in a unit count amount equal to the ledger unit count (Cl), signal the POS system when the ledger transfer is confirmed, and determine the charge amount (C) based on a second rule comprising C=(Ut−Ul)*Cp. and communicate the charge amount to the POS system to complete the transaction.

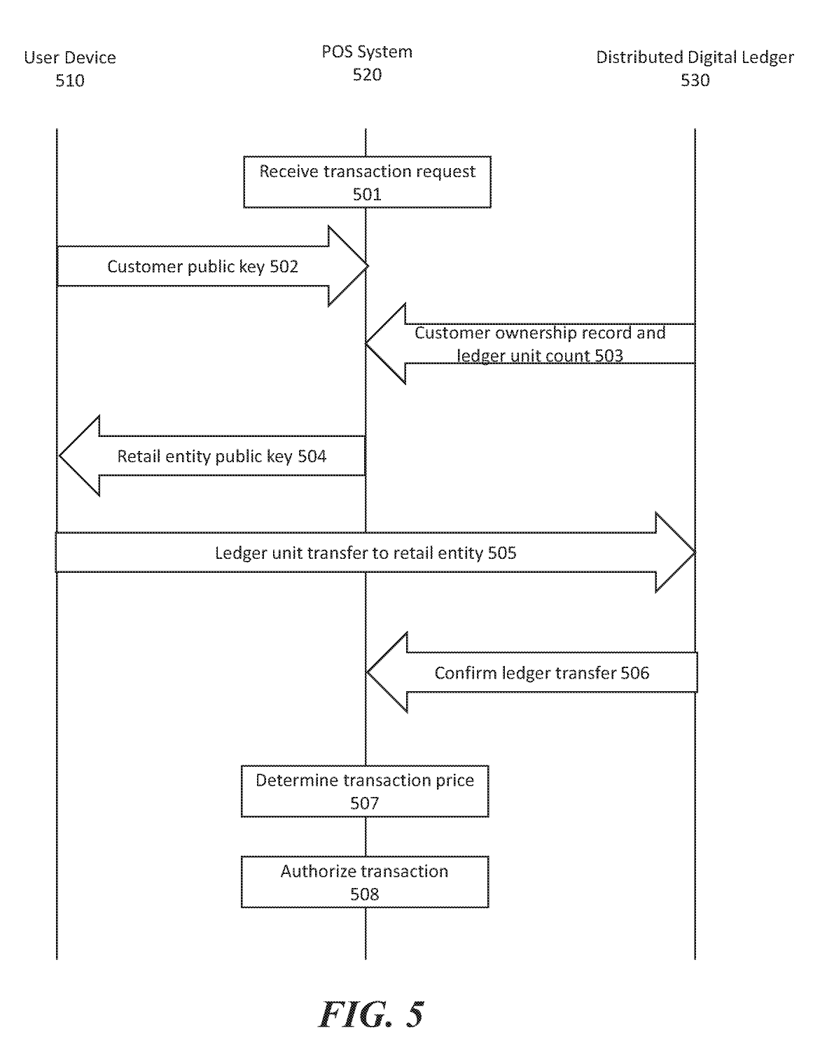

Referring now to FIG. 5, a process for operating an electronic checkout system is shown. In some embodiments, the steps shown in FIG. 5 comprise information exchanges between a user device 510, a POS system 520, and a distributed digital ledger 530. In some embodiments, the user device 510, the POS system 520, and the distributed digital ledger 530 may comprise the user device 130, the POS system 120, and the distributed digital ledger 110 described with reference to FIG. 1, respectively, or similar devices.

While the distributed digital ledger 530 is shown separate from the POS systems 520 and the user device 510 for illustrative purposes, it is understood that the distributed digital ledger 530, being distributed, may comprise data stored on one or more POS systems, user devices, and/or other devices, including the POS system 520 and/or user Device 510. In some embodiments, a POS system 520 may store a portion or a copy of the entire distributed digital ledger 530.

In step 501, the POS system 520 receives a transaction request. The transaction request may comprise the selection of one or more products and transfer unit counts for each selected product. In some embodiments, step 501 may comprise step 302, step 402, or a similar step. In step 502, the POS system 520 receives the customer's public key. In some embodiments, a mobile application on the user device 510 may display a QR code or Barcode to be scanned by an optical scanner of the POS system 520. In some embodiments, the public key may be provided via NFC. In some embodiments, the POS system 520 may receive a customer account identifier instead of a public key. In some embodiments, step 502 may comprise step 302 or a similar step.

In step 503, the POS system 520 retrieves the customer's ownership record from the distributed digital ledger 530 using the public key and/or account identified receive in step 502. In some embodiments, the POS system 520 may verify that the customer's account has sufficient ledger unit count for the transaction based on the transaction records in the distributed digital ledger. In some embodiments, the system may maintain an indexed customer ownership database that is periodically updated and step 503 may comprise retrieving customer account information from the previously indexed database. In some embodiments, the POS system 520 may instead request a proof of ownership from the user device 510 and retrieve the proof of ownership from the distributed digital ledger 530. In some embodiments, after step 503, the POS system 520 may determine how many ledger units needs to be transferred from the distributed ledger and request the number of units from the customer via POS display, in-app messaging, etc. In some embodiments, step 502 may comprise step 303 or a similar step.

In step 504, the POS system 520 provides the retail entity public key to the customer user device 510. In some embodiments, the retail entity public key may be displayed on a display screen of the POS system or be printed as an image, text, optical code, etc. In some embodiments, the retail entity public key may be transmitted via NFC or WiFi. In some embodiments, the retail entity public key may be provided prior to the transaction request and stored on the user device 510 for repeated use. In some embodiments, step 504 may comprise step 311, step 404, or a similar step.

In step 505, the customer uses the user device 510 to make a ledger unit transfer to the retail entity account. The transaction is sent to nodes of the distributed digital ledger 530 as an update to the distributed ledger that subtracts from the ledger unit count of the customer's account. In some embodiments, the transaction may be similar to a transfer in a blockchain based cryptocurrency. In step 506, the POS system 520 verifies the ledger transfer based on updates to the distributed digital ledger 530. For example, the POS system 520 may verify that the customer account had the required ledger unit count initially and that a transaction record for the transfer has been verified and added to the distributed digital ledger. In some embodiments, step 504 may comprise step 313, step 405, or a similar step.

In step 507, the POS system 520 may determine whether any amount is owed after the ledger transfer 506. For example, if the customer requests to receive more product than they have in the distributed ledger ownership record, the POS system 520 may charge the customer for the remaining products. In some embodiments, step 507 may comprise step 321, step 411, step 431, or a similar step. In some embodiments, if the customer pays for more units than they receive, after 507, the POS system may update the distributed digital ledger to transfer ledger unit counts to the customer. In step 508, the POS system authorizes the transaction. In some embodiments, step 504 may comprise step 330, step 432, or a similar step.

In some embodiments, with the methods and system described herein, a distributed digital ledger of ownership records provides purchase and conveyance flexibility to customers. Customers can essentially use store shelves, distribution centers, and/or vending machines of retail entities as their inventory storage space and take advantage of promotions and bulk discounts. For example, if paper towels are on sale, a customer can purchase a large quantity (e.g. 100 rolls) without having to store the products in their residence. Instead, the customer can pick up products they purchased or request the products to be delivered when they need them. Customers can also pick up products at different locations of their choosing. For example, a customer may purchase products at their home store and up products in a different store when they are traveling without paying. In another example, a customer may purchase soda online and get a cold soda from vending machines while they are out and about without paying at the vending machines. The prices they paid online may also be less than the price charged at the vending machines. In some embodiments, the distributed digital ledger of ownership records may also be used for peer-to-peer ownership transfers such as gifting and reselling. For example, a customer may gift a ledger unit to a friend who lives across the country. The friend can then pick up the product at a local store at a later time instead of having the product sent across the country.

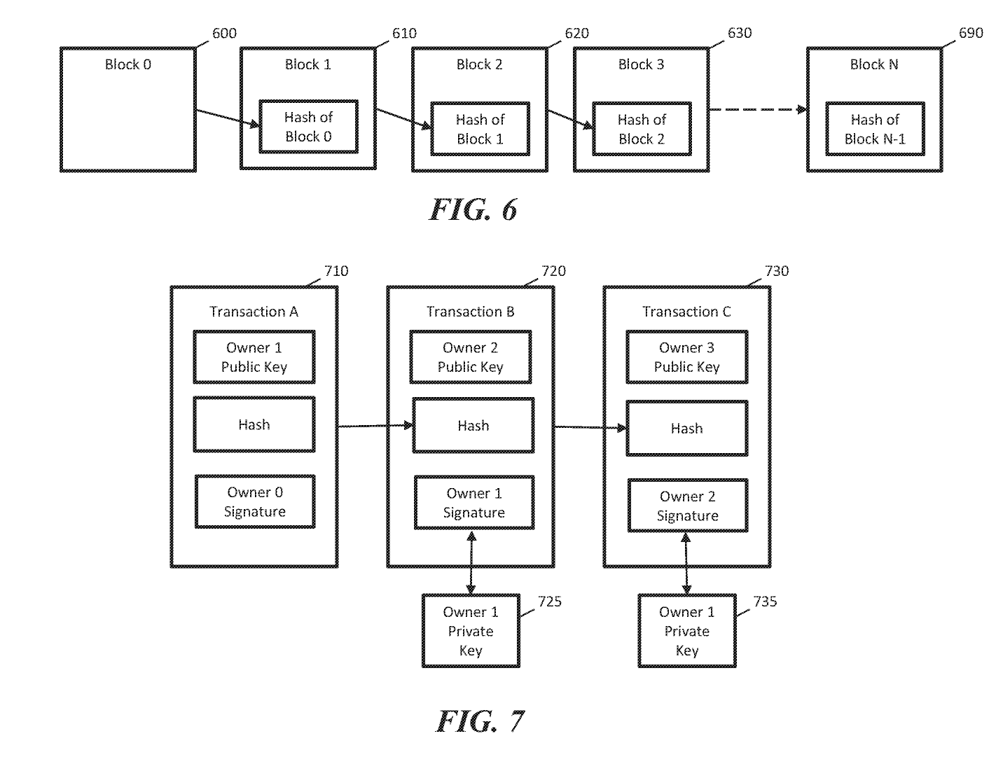

Descriptions of some embodiments of blockchain technology are provided with reference to FIGS. 6-11 herein. In some embodiments of the invention described above, blockchain technology may be utilized to record autonomous vehicle task transfers and master role reassignments. One or more of the autonomous vehicles and servers described herein may comprise a node in a distributed blockchain system storing a copy of the blockchain record. Updates to the blockchain may comprise vehicle task assignments, statuses, and authorization information and one or more nodes in the system may be configured to incorporate one or more updates into blocks to add to the distributed database. In some embodiments, the nodes of the blockchain may be configured to enforce fleet rules, task transfer rules, and master reassignment rules through consensus.

Distributed database and shared ledger database generally refer to methods of peer-to-peer record keeping and authentication in which records are kept at multiple nodes in the peer-to-peer network instead of kept at a trusted party. A blockchain may generally refer to a distributed database that maintains a growing list of records in which each block contains a hash of some or all previous records in the chain to secure the record from tampering and unauthorized revision. A hash generally refers to a derivation of original data. In some embodiments, the hash in a block of a blockchain may comprise a cryptographic hash that is difficult to reverse and/or a hash table. Blocks in a blockchain may further be secured by a system involving one or more of a distributed timestamp server, cryptography, public/private key authentication and encryption, proof standard (e.g. proof-of-work, proof-of-stake, proof-of-space), and/or other security, consensus, and incentive features. In some embodiments, a block in a blockchain may comprise one or more of a data hash of the previous block, a timestamp, a cryptographic nonce, a proof standard, and a data descriptor to support the security and/or incentive features of the system.

In some embodiments, a blockchain system comprises a distributed timestamp server comprising a plurality of nodes configured to generate computational proof of record integrity and the chronological order of its use for content, trade, and/or as a currency of exchange through a peer-to-peer network. In some embodiments, when a blockchain is updated, a node in the distributed timestamp server system takes a hash of a block of items to be timestamped and broadcasts the hash to other nodes on the peer-to-peer network. The timestamp in the block serves to prove that the data existed at the time in order to get into the hash. In some embodiments, each block includes the previous timestamp in its hash, forming a chain, with each additional block reinforcing the ones before it. In some embodiments, the network of timestamp server nodes performs the following steps to add a block to a chain: 1) new activities are broadcasted to all nodes, 2) each node collects new activities into a block, 3) each node works on finding a difficult proof-of-work for its block, 4) when a node finds a proof-of-work, it broadcasts the block to all nodes, 5) nodes accept the block only if activities are authorized, and 6) nodes express their acceptance of the block by working on creating the next block in the chain, using the hash of the accepted block as the previous hash. In some embodiments, nodes may be configured to consider the longest chain to be the correct one and work on extending it. A digital currency implemented on a blockchain system is described by Satoshi Nakamoto in “Bitcoin: A Peer-to-Peer Electronic Cash System” (http://bitcoin.org/bitcoin.pdf), the entirety of which is incorporated herein by reference.

Now referring to FIG. 6, an illustration of a blockchain according to some embodiments is shown. In some embodiments, a blockchain comprises a hash chain or a hash tree in which each block added in the chain contains a hash of the previous block. In FIG. 6, block 0 600 represents a genesis block of the chain. Block 1 610 contains a hash of block 0 600, block 2 620 contains a hash of block 1 610, block 3 630 contains a hash of block 2 620, and so forth. Continuing down the chain, block N contains a hash of block N−1. In some embodiments, the hash may comprise the header of each block. Once a chain is formed, modifying or tampering with a block in the chain would cause detectable disparities between the blocks. For example, if block 1 is modified after being formed, block 1 would no longer match the hash of block 1 in block 2. If the hash of block 1 in block 2 is also modified in an attempt to cover up the change in block 1, block 2 would not then match with the hash of block 2 in block 3. In some embodiments, a proof standard (e.g. proof-of-work, proof-of-stake, proof-of-space, etc.) may be required by the system when a block is formed to increase the cost of generating or changing a block that could be authenticated by the consensus rules of the distributed system, making the tampering of records stored in a blockchain computationally costly and essentially impractical. In some embodiments, a blockchain may comprise a hash chain stored on multiple nodes as a distributed database and/or a shared ledger, such that modifications to any one copy of the chain would be detectable when the system attempts to achieve consensus prior to adding a new block to the chain. In some embodiments, a block may generally contain any type of data and record. In some embodiments, each block may comprise a plurality of transaction and/or activity records.

In some embodiments, blocks may contain rules and data for authorizing different types of actions and/or parties who can take action. In some embodiments, transaction and block forming rules may be part of the software algorithm on each node. When a new block is being formed, any node on the system can use the prior records in the blockchain to verify whether the requested action is authorized. For example, a block may contain a public key of an owner of an asset that allows the owner to show possession and/or transfer the asset using a private key. Nodes may verify that the owner is in possession of the asset and/or is authorized to transfer the asset based on prior transaction records when a block containing the transaction is being formed and/or verified. In some embodiments, rules themselves may be stored in the blockchain such that the rules are also resistant to tampering once created and hashed into a block. In some embodiments, the blockchain system may further include incentive features for nodes that provide resources to form blocks for the chain. For example, in the Bitcoin system, “miners' are nodes that compete to provide proof-of-work to form a new block, and the first successful miner of a new block earns Bitcoin currency in return.

Now referring to FIG. 7, an illustration of blockchain based transactions according to some embodiments is shown. In some embodiments, the blockchain illustrated in FIG. 7 comprises a hash chain protected by private/public key encryption. Transaction A 710 represents a transaction recorded in a block of a blockchain showing that owner 1 (recipient) obtained an asset from owner 0 (sender). Transaction A 710 contains owner's 1 public key and owner 0's signature for the transaction and a hash of a previous block. When owner 1 transfers the asset to owner 2, a block containing transaction B 720 is formed. The record of transaction B 720 comprises the public key of owner 2 (recipient), a hash of the previous block, and owner 1's signature for the transaction that is signed with the owner 1's private key 725 and verified using owner 1's public key in transaction A 710. When owner 2 transfers the asset to owner 3, a block containing transaction C 730 is formed. The record of transaction C 730 comprises the public key of owner 3 (recipient), a hash of the previous block, and owner 2's signature for the transaction that is signed by owner 2's private key 735 and verified using owner 2's public key from transaction B 220. In some embodiments, when each transaction record is created, the system may check previous transaction records and the current owner's private and public key signature to determine whether the transaction is valid. In some embodiments, transactions are broadcasted in the peer-to-peer network and each node on the system may verify that the transaction is valid prior to adding the block containing the transaction to their copy of the blockchain. In some embodiments, nodes in the system may look for the longest chain in the system to determine the most up-to-date transaction record to prevent the current owner from double spending the asset. The transactions in FIG. 7 are shown as an example only. In some embodiments, a blockchain record and/or the software algorithm may comprise any type of rules that regulate who and how the chain may be extended. In some embodiments, the rules in a blockchain may comprise clauses of a smart contract that is enforced by the peer-to-peer network.

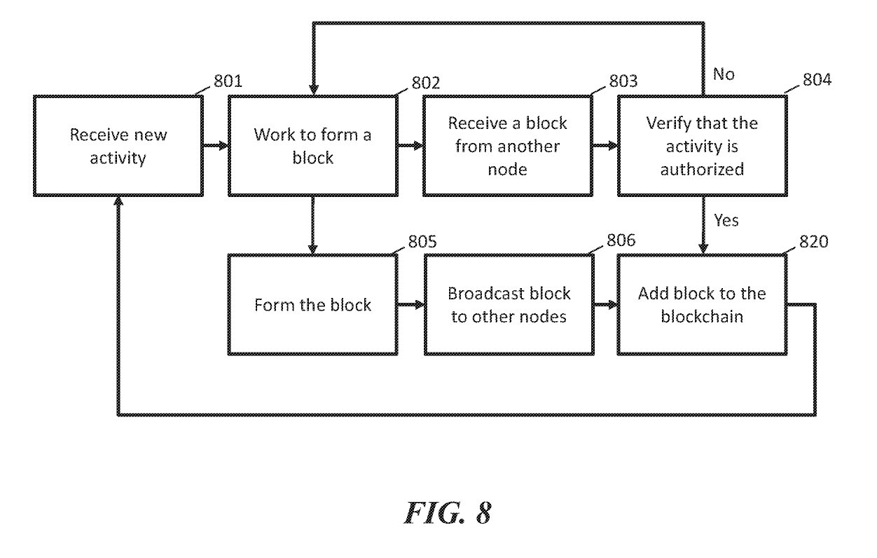

Now referring to FIG. 8, a flow diagram according to some embodiments is shown. In some embodiments, the steps shown in FIG. 8 may be performed by a processor-based device, such as a computer system, a server, a distributed server, a timestamp server, a blockchain node, and the like. In some embodiments, the steps in FIG. 8 may be performed by one or more of the nodes in a system using blockchain for record keeping.

In step 801, a node receives a new activity. The new activity may comprise an update to the record being kept in the form of a blockchain. In some embodiments, for blockchain supported digital or physical asset record keeping, the new activity may comprise an asset transaction. In some embodiments, the new activity may be broadcasted to a plurality of nodes on the network prior to step 801. In step 802, the node works to form a block to update the blockchain. In some embodiments, a block may comprise a plurality of activities or updates and a hash of one or more previous block in the blockchain. In some embodiments, the system may comprise consensus rules for individual transactions and/or blocks and the node may work to form a block that conforms to the consensus rules of the system. In some embodiments, the consensus rules may be specified in the software program running on the node. For example, a node may be required to provide a proof standard (e.g. proof of work, proof of stake, etc.) which requires the node to solve a difficult mathematical problem for form a nonce in order to form a block. In some embodiments, the node may be configured to verify that the activity is authorized prior to working to form the block. In some embodiments, whether the activity is authorized may be determined based on records in the earlier blocks of the blockchain itself.

After step 802, if the node successfully forms a block in step 805 prior to receiving a block from another node, the node broadcasts the block to other nodes over the network in step 806. In some embodiments, in a system with incentive features, the first node to form a block may be permitted to add incentive payment to itself in the newly formed block. In step 820, the node then adds the block to its copy of the blockchain. In the event that the node receives a block formed by another node in step 803 prior to being able to form the block, the node works to verify that the activity recorded in the received block is authorized in step 804. In some embodiments, the node may further check the new block against system consensus rules for blocks and activities to verify whether the block is properly formed. If the new block is not authorized, the node may reject the block update and return to step 802 to continue to work to form the block. If the new block is verified by the node, the node may express its approval by adding the received block to its copy of the blockchain in step 820. After a block is added, the node then returns to step 801 to form the next block using the newly extended blockchain for the hash in the new block.

In some embodiments, in the event one or more blocks having the same block number is received after step 820, the node may verify the later arriving blocks and temporarily store these block if they pass verification. When a subsequent block is received from another node, the node may then use the subsequent block to determine which of the plurality of received blocks is the correct/consensus block for the blockchain system on the distributed database and update its copy of the blockchain accordingly. In some embodiments, if a node goes offline for a time period, the node may retrieve the longest chain in the distributed system, verify each new block added since it has been offline, and update its local copy of the blockchain prior to proceeding to step 801.

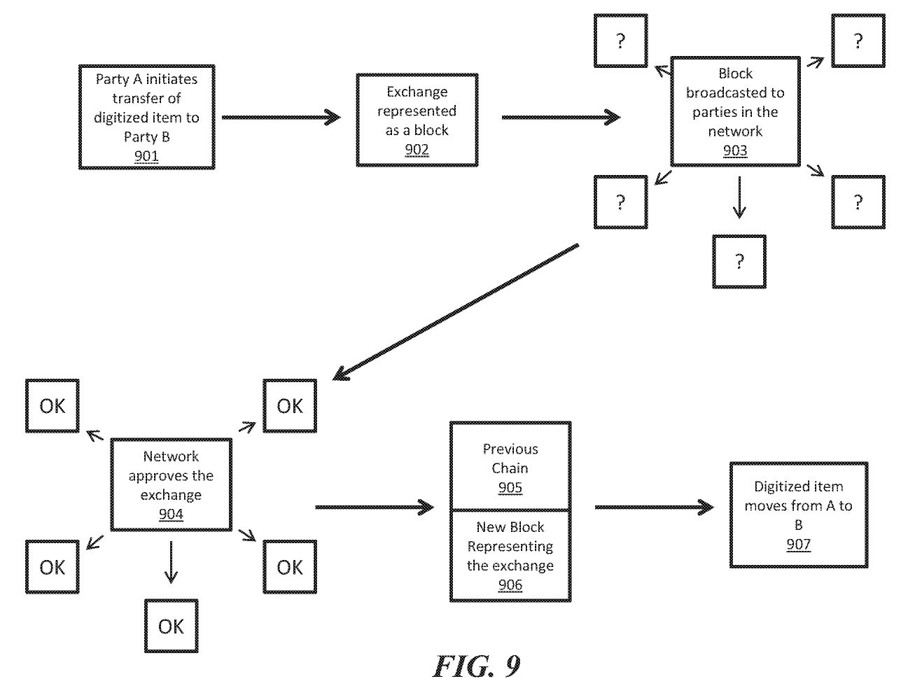

Now referring to FIG. 9, a process diagram a blockchain update according to some implementations is shown. In step 901, party A initiates the transfer of a digitized item to party B. In some embodiments, the digitized item may comprise a digital currency, a digital asset, a document, rights to a physical asset, etc. In some embodiments, Party A may prove that he has possession of the digitized item by signing the transaction with a private key that may be verified with a public key in the previous transaction of the digitized item. In step 902, the exchange initiated in step 901 is represented as a block. In some embodiments, the transaction may be compared with transaction records in the longest chain in the distributed system to verify part A's ownership. In some embodiments, a plurality of nodes in the network may compete to form the block containing the transaction record. In some embodiments, nodes may be required to satisfy proof-of-work by solving a difficult mathematical problem to form the block. In some embodiments, other methods of proof such as proof-of-stake, proof-of-space, etc. may be used in the system. In some embodiments, the node that is first to form the block may earn a reward for the task as incentive. For example, in the Bitcoin system, the first node to provide proof of work to for block the may earn a Bitcoin. In some embodiments, a block may comprise one or more transactions between different parties that are broadcasted to the nodes. In step 903, the block is broadcasted to parties in the network. In step 904, nodes in the network approve the exchange by examining the block that contains the exchange. In some embodiments, the nodes may check the solution provided as proof-of-work to approve the block. In some embodiments, the nodes may check the transaction against the transaction record in the longest blockchain in the system to verify that the transaction is valid (e.g. party A is in possession of the asset he/she seeks to transfer). In some embodiments, a block may be approved with consensus of the nodes in the network. After a block is approved, the new block 906 representing the exchange is added to the existing chain 905 comprising blocks that chronologically precede the new block 906. The new block 906 may contain the transaction(s) and a hash of one or more blocks in the existing chain 905. In some embodiments, each node may then update their copy of the blockchain with the new block and continue to work on extending the chain with additional transactions. In step 907, when the chain is updated with the new block, the digitized item is moved from party A to party B.

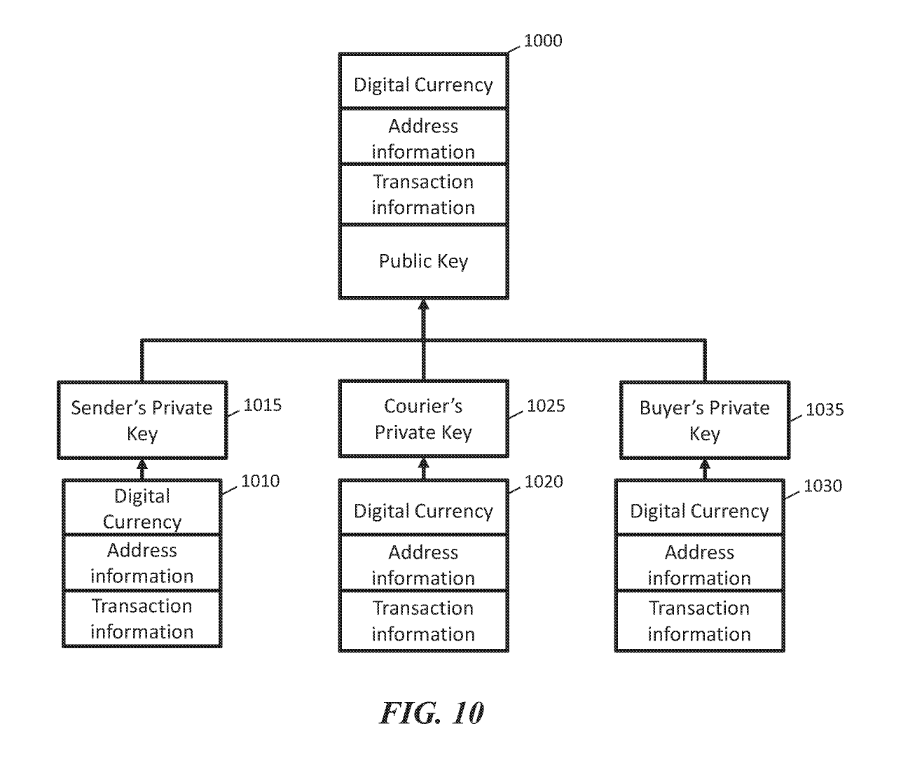

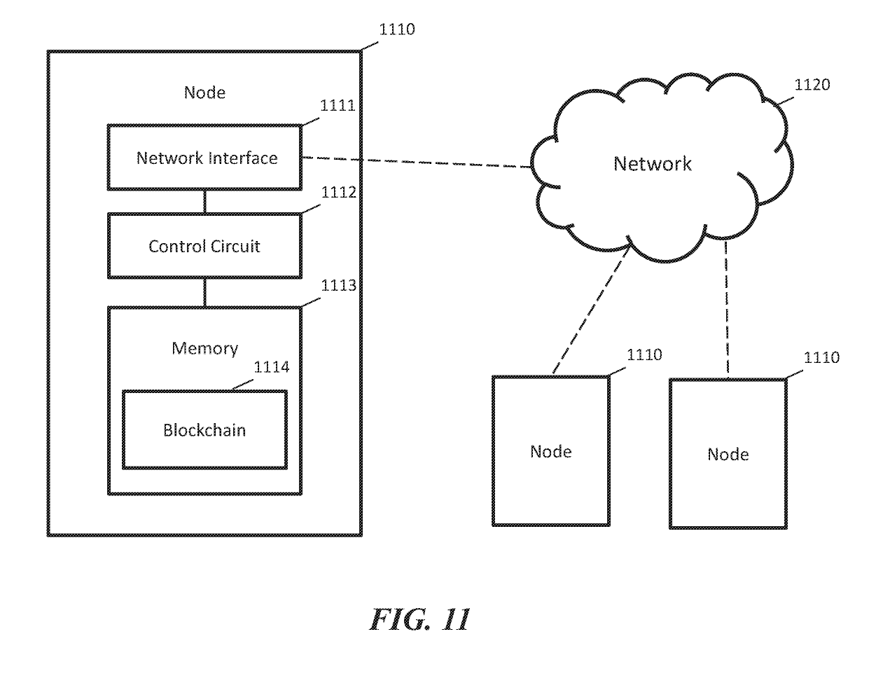

Now referring to FIG. 10, a diagram of a blockchain according to some embodiments is shown. FIG. 10 comprises an example of an implementation of a blockchain system for delivery service record keeping. The delivery record 1000 comprises digital currency information, address information, transaction information, and a public key associated with one or more of a sender, a courier, and a buyer. In some embodiments, nodes associated the sender, the courier, and the buyer may each store a copy of the delivery record 1010, 1020, and 1030 respectively. In some embodiments, the delivery record 1000 comprises a public key that allows the sender, the courier, and/or the buyer to view and/or update the delivery record 1000 using their private keys 1015, 1025, and 1035 respectively. For example, when a package is transferred from a sender to the courier, the sender may use the sender's private key 1015 to authorize the transfer of a digital asset representing the physical asset from the sender to the courier and update the delivery record with the new transaction. In some embodiments, the transfer from the seller to the courier may require signatures from both the sender and the courier using their respective private keys. The new transaction may be broadcasted and verified by the sender, the courier, the buyer, and/or other nodes on the system before being added to the distributed delivery record blockchain. When the package is transferred from the courier to the buyer, the courier may use the courier's private key 1025 to authorize the transfer of the digital asset representing the physical asset from the courier to the buyer and update the delivery record with the new transaction. In some embodiments, the transfer from the courier to the buyer may require signatures from both the courier and the buyer using their respective private keys. The new transaction may be broadcasted and verified by the sender, the courier, the buyer, and/or other nodes on the system before being added to the distributed delivery record blockchain.

With the scheme shown in FIG. 10, the delivery record may be updated by one or more of the sender, courier, and the buyer to form a record of the transaction without a trusted third party while preventing unauthorized modifications to the record. In some embodiments, the blockchain based transactions may further function to include transfers of digital currency with the completion of the transfer of physical asset. With the distributed database and peer-to-peer verification of a blockchain system, the sender, the courier, and the buyer can each have confidence in the authenticity and accuracy of the delivery record stored in the form of a blockchain.

Now referring to FIG. 11, a system according to some embodiments is shown. A distributed blockchain system comprises a plurality of nodes 1110 communicating over a network 1120. In some embodiments, the nodes 1110 may comprise a distributed blockchain server and/or a distributed timestamp server. In some embodiments, one or more nodes 1110 may comprise or be similar to a “miner” device on the Bitcoin network. Each node 1110 in the system comprises a network interface 1111, a control circuit 1112, and a memory 1113.

The control circuit 1112 may comprise a processor, a microprocessor, and the like and may be configured to execute computer readable instructions stored on a computer readable storage memory 1113. The computer readable storage memory may comprise volatile and/or non-volatile memory and have stored upon it a set of computer readable instructions which, when executed by the control circuit 1112, causes the node 1110 update the blockchain 1114 stored in the memory 1113 based on communications with other nodes 1110 over the network 1120. In some embodiments, the control circuit 1112 may further be configured to extend the blockchain 1114 by processing updates to form new blocks for the blockchain 1114. Generally, each node may store a version of the blockchain 1114, and together, may form a distributed database. In some embodiments, each node 1110 may be configured to perform one or more steps described with reference to FIGS. 2-10 herein.

The network interface 1111 may comprise one or more network devices configured to allow the control circuit to receive and transmit information via the network 1120. In some embodiments, the network interface 1111 may comprise one or more of a network adapter, a modem, a router, a data port, a transceiver, and the like. The network 1120 may comprise a communication network configured to allow one or more nodes 1110 to exchange data. In some embodiments, the network 1120 may comprise one or more of the Internet, a local area network, a private network, a virtual private network, a home network, a wired network, a wireless network, and the like. In some embodiments, the system does not include a central server and/or a trusted third party system. Each node in the system may enter and leave the network at any time.

With the system and processes shown in, once a block is formed, the block cannot be changed without redoing the work to satisfy census rules thereby securing the block from tampering. A malicious attacker would need to provide proof standard for each block subsequent to the one he/she seeks to modify, race all other nodes, and overtake the majority of the system to affect change to an earlier record in the blockchain.

In some embodiments, blockchain may be used to support a payment system based on cryptographic proof instead of trust, allowing any two willing parties to transact directly with each other without the need for a trusted third party. Bitcoin is an example of a blockchain backed currency. A blockchain system uses a peer-to-peer distributed timestamp server to generate computational proof of the chronological order of transactions. Generally, a blockchain system is secure as long as honest nodes collectively control more processing power than any cooperating group of attacker nodes. With a blockchain, the transaction records are computationally impractical to reverse. As such, sellers are protected from fraud and buyers are protected by the routine escrow mechanism.

In some embodiments, a blockchain may use to secure digital documents such as digital cash, intellectual property, private financial data, chain of title to one or more rights, real property, digital wallet, digital representation of rights including, for example, a license to intellectual property, digital representation of a contractual relationship, medical records, security clearance rights, background check information, passwords, access control information for physical and/or virtual space, and combinations of one of more of the foregoing that allows online interactions directly between two parties without going through an intermediary. With a blockchain, a trusted third party is not required to prevent fraud. In some embodiments, a blockchain may include peer-to-peer network timestamped records of actions such as accessing documents, changing documents, copying documents, saving documents, moving documents, or other activities through which the digital content is used for its content, as an item for trade, or as an item for remuneration by hashing them into an ongoing chain of hash-based proof-of-work to form a record that cannot be changed in accord with that timestamp without redoing the proof-of-work.

In some embodiments, in the peer-to-peer network, the longest chain proves the sequence of events witnessed, proves that it came from the largest pool of processing power, and that the integrity of the document has been maintained. In some embodiments, the network for supporting blockchain based record keeping requires minimal structure. In some embodiments, messages for updating the record are broadcast on a best-effort basis. Nodes can leave and rejoin the network at will and may be configured to accept the longest proof-of-work chain as proof of what happened while they were away.

In some embodiments, a blockchain based system allows content use, content exchange, and the use of content for remuneration based on cryptographic proof instead of trust, allowing any two willing parties to employ the content without the need to trust each other and without the need for a trusted third party. In some embodiments, a blockchain may be used to ensure that a digital document was not altered after a given timestamp, that alterations made can be followed to a traceable point of origin, that only people with authorized keys can access the document, that the document itself is the original and cannot be duplicated, that where duplication is allowed and the integrity of the copy is maintained along with the original, that the document creator was authorized to create the document, and/or that the document holder was authorized to transfer, alter, or otherwise act on the document.

As used herein, in some embodiments, the term blockchain may refer to one or more of a hash chain, a hash tree, a distributed database, and a distributed ledger. In some embodiments, blockchain may further refer to systems that use one or more of cryptography, private/public key encryption, proof standard, distributed timestamp server, and inventive schemes to regulate how new blocks may be added to the chain. In some embodiments, blockchain may refer to the technology that underlies the Bitcoin system, a “sidechain” that uses the Bitcoin system for authentication and/or verification, or an alternative blockchain (“altchain”) that is based on bitcoin concept and/or code but are generally independent of the Bitcoin system.

Descriptions of embodiments of blockchain technology are provided herein as illustrations and examples only. The concepts of the blockchain system may be variously modified and adapted for different applications.

In some embodiments, a system comprises a plurality of point of sale (POS) systems comprising nodes of a distributed digital ledger, wherein the distributed digital ledger comprises ownership records associated with a plurality of user accounts that are updated and verified collectively by the plurality of POS systems, and wherein the distributed digital ledger is configured to be used by one or more of the plurality of POS systems to authorize transfer of items specified in the ownership records to customers. A POS system in the plurality of POS systems comprises a memory device configured to store at least a portion of the distributed digital ledger, an optical scanner configured to detect product identifiers and/or user account identifiers, and a control circuit coupled to the memory device and the optical scanner, the control circuit being configured to periodically communicate with others of the plurality of POS systems to update the ownership records in the at least a portion of the distributed digital ledger, receive a transaction request comprising a product identifier associated with a product and a transfer unit count (Ut) wherein the transfer unit count (Ut) corresponds to units of product the customer wishes to take into physical prosession, receive, from a customer via the optical scanner, a public key associated with a user account, index the distributed digital ledger using the public key associated with the user account for ownership records associated with the user account to determine a ledger unit count (Ul) associated with the product identifier, wherein the ledger unit count (Ul) corresponds to product units previously added to the user account and not yet physically conveyed, in the event the transfer unit count is equal or lesser than the ledger unit count (Ut≤Ul): provide a public key associated with the retail entity account to the customer, request the user account for a ledger transfer from the user account to a retail entity account associated with the POS system in a unit count amount equal to the transfer unit (Ut), wherein the ledger transfer is broadcasted to the plurality of POS systems for verification; confirm the ledger transfer to the retail entity account based on updates to the distributed digital ledger and authorize the transaction request at the POS system in response to confirming the ledger transfer.

In some embodiments, a method for operating rule-based electronic checkout systems comprises establishing connection between a point of sale (POS) system and with a plurality of POS systems comprising nodes of a distributed digital ledger, wherein the distributed digital ledger comprises ownership records associated with a plurality of user accounts that are updated and verified collectively by the plurality of POS systems, and wherein the distributed digital ledger is configured to be used by one or more of the plurality of POS systems to authorize transfer of items specified in the ownership records to customers, storing at least a portion of the distributed digital ledger in a memory device of the POS system, periodically updating the ownership records in the at least a portion of the distributed digital ledger based on communications with at least some of the plurality of POS systems, receiving, at the POS system, a transaction request comprising a product identifier associated with a product and a transfer unit count (Ut) wherein the transfer unit count (Ut) corresponds to units of product the customer wishes to take into physical prosession, receiving, from a customer and via an optical scanner of the POS system, a public key associated with a user account, indexing, with a control circuit of the POS system, the distributed digital ledger using the public key associated with the user account for ownership records associated with the user account to determine a ledger unit count (Ul) associated with the product identifier, wherein the ledger unit count (Ul) corresponds to product units previously added to the user account and not yet physically conveyed, in the event the transfer unit count is equal or lesser than the ledger unit count (Ut≤Ul): providing a public key associated with the retail entity account to the customer, requesting the user account for a ledger transfer from the user account to a retail entity account associated with the POS system in a unit count amount equal to the transfer unit (Ut), wherein the ledger transfer is broadcasted to the plurality of POS systems for verification, confirming, at the POS system, the ledger transfer to the retail entity account based on updates to the distributed digital ledger, and authorizing the transaction request at the POS system in response to confirming the ledger transfer.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A rule-based electronic checkout system, the system comprises:
a plurality of point of sale (POS) systems comprising nodes of a distributed digital ledger, wherein the distributed digital ledger comprises ownership records associated with a plurality of user accounts that are updated and verified collectively by the plurality of POS systems, and wherein the distributed digital ledger is configured to be used by one or more of the plurality of POS systems to authorize transfer of items specified in the ownership records to customers;
a POS system in the plurality of POS systems comprises:
a memory device configured to store at least a portion of the distributed digital ledger;
an optical scanner configured to detect product identifiers and/or user account identifiers; and
a control circuit coupled to the memory device and the optical scanner, the control circuit being configured to:
periodically communicate with others of the plurality of POS systems to update the ownership records in the at least a portion of the distributed digital ledger;
receive a transaction request comprising a product identifier associated with a product and a transfer unit count (Ut) wherein the transfer unit count (Ut) corresponds to units of product the customer wishes to take into physical possession;
receive, from a customer via the optical scanner, a public key associated with a user account,
index the distributed digital ledger using the public key associated with the user account for ownership records associated with the user account to determine a ledger unit count (Ul) associated with the product identifier, wherein the ledger unit count (Ul) corresponds to product units previously added to the user account and not yet physically conveyed;
in the event the transfer unit count is equal or lesser than the ledger unit count (Ut≤Ul):
provide a public key associated with the retail entity account to the customer;
request the user account for a ledger transfer from the user account to a retail entity account associated with the POS system in a unit count amount equal to the transfer unit (Ut), wherein the ledger transfer is broadcasted to the plurality of POS systems for verification;
confirm the ledger transfer to the retail entity account based on updates to the distributed digital ledger; and
authorize the transaction request at the POS system in response to confirming the ledger transfer.

2. The system of claim 1 wherein the distributed digital ledger comprises one or more of a shared ledger, a distributed database, a blockchain database, and a blockchain-based database.

3. The system of claim 1, wherein the nodes of the distributed digital ledger comprise systems associated with two or more of retailers, manufacturers, suppliers, and customers.

4. The system of claim 1, wherein in the event that the transfer count is greater than the ledger unit count (Ut>Ul) the control circuit is further configured to determine a transaction price based on the difference between the ledger unit count and the transfer unit count (Ut−Ul) and a unit price of the product.

5. The system of claim 1, wherein the public key associated with the user account comprises an optical code displayed on a user device and scanned by the POS system.

6. The system of claim 1, wherein the transfer unit count corresponds to a number of products the customer carries to a checkout counter in a retail store.

7. The system of claim 1, wherein the POS system comprises an automated item dispensing machine.

8. The system of claim 1, wherein the control circuit is further configured to:
receive a ledger purchase request comprising a product identifier associated with a product to purchase, a purchase unit count (Up), and a public key associated with receiving user account.

9. The system of claim 8, wherein the ledger purchase request comprises a gift purchase from a first customer to a second customer associated with the receiving user account.

10. The system of claim 8, wherein the ledger purchase request comprises a peer-to-peer transfer of ownership from one user account to the receiving user account.

11. A method for operating rule-based electronic checkout systems, the method comprises:
establishing connection between a point of sale (POS) system and with a plurality of POS systems comprising nodes of a distributed digital ledger, wherein the distributed digital ledger comprises ownership records associated with a plurality of user accounts that are updated and verified collectively by the plurality of POS systems, and wherein the distributed digital ledger is configured to be used by one or more of the plurality of POS systems to authorize transfer of items specified in the ownership records to customers;
storing at least a portion of the distributed digital ledger in a memory device of the POS system;
periodically updating the ownership records in the at least a portion of the distributed digital ledger based on communications with at least some of the plurality of POS systems;
receiving, at the POS system, a transaction request comprising a product identifier associated with a product and a transfer unit count (Ut) wherein the transfer unit count (Ut) corresponds to units of product the customer wishes to take into physical possession;
receiving, from a customer and via an optical scanner of the POS system, a public key associated with a user account;
indexing, with a control circuit of the POS system, the distributed digital ledger using the public key associated with the user account for ownership records associated with the user account to determine a ledger unit count (Ul) associated with the product identifier, wherein the ledger unit count (Ul) corresponds to product units previously added to the user account and not yet physically conveyed;
in the event the transfer unit count is equal or lesser than the ledger unit count (Ut≤Ul):
providing a public key associated with the retail entity account to the customer;
requesting the user account for a ledger transfer from the user account to a retail entity account associated with the POS system in a unit count amount equal to the transfer unit (Ut), wherein the ledger transfer is broadcasted to the plurality of POS systems for verification;
confirming, at the POS system, the ledger transfer to the retail entity account based on updates to the distributed digital ledger; and
authorizing the transaction request at the POS system in response to confirming the ledger transfer.

12. The method of claim 11, wherein the distributed digital ledger comprises one or more of a shared ledger, a distributed database, a blockchain database, and a blockchain-based database.

13. The method of claim 11, wherein the nodes of the distributed digital ledger comprise systems associated with two or more of retailers, manufacturers, suppliers, and customers.

14. The method of claim 11, wherein in the event that the transfer count is greater than the ledger unit count (Ut>Ul) the control circuit is further configured to determine a transaction price based on the difference between the ledger unit count and the transfer unit count (Ut−Ul) and a unit price of the product.

15. The method of claim 11, wherein the public key associated with the user account comprises an optical code displayed on a user device and scanned by the POS system.

16. The method of claim 11, wherein the transfer unit count corresponds to a number of products the customer carries to a checkout counter in a retail store.

17. The method of claim 11, wherein the POS system comprises an automated item dispensing machine.

18. The method of claim 11, further comprising:
receiving a ledger purchase request comprising a product identifier associated with a product to purchase, a purchase unit count (Up), and a public key associated with receiving user account.

19. The method of claim 18, wherein the ledger purchase request comprises a gift purchase from a first customer to a second customer associated with the receiving user account.

20. The method of claim 18, wherein the ledger purchase request comprises a peer-to-peer transfer of ownership from one user account to the receiving user account.
